(19) United States
(12) Patent Application Publication
(10) Pub. No.: US 2010/0107811 A1
(43) Pub. Date: May 6, 2010

(54) Range and Mode Shift System for Two-Speed On-Demand Transfer Case

(76) Inventor: Chad McCloy, Cortland, NY (US)

Correspondence Address: MAGNA INTERNATIONAL, INC., 337 MAGNA DRIVE, AURORA, ON, L4G-7K1, CA

(21) Appl. No.: 12/531,359

(22) PCT Filed: Mar. 11, 2008
(86) PCT No.: PCT/US08/03212

§ 371 Date: Jan. 6, 2010

Related U.S. Application Data
(60) Provisional application No. 60/918,236, filed on Mar. 15, 2007.

(51) Int. Cl. B60K 17/344; F16H 59/08

(52) U.S. Cl. 74/665 F; 74/473.12

(57) ABSTRACT

A transfer case equipped with a two-speed range unit, a mode clutch assembly and a power-operated actuation mechanism for controlling coordinated actuation of the range unit and the mode clutch assembly is disclosed. In addition, the transfer case is interactively associated with a control system for controlling operation of the power-operated actuation mechanism to establish a plurality of distinct two-wheel and four-wheel drive modes.

### FIELD

The present disclosure relates generally to power transfer systems for controlling the distribution of drive torque between the front and rear drivelines of a four-wheel drive vehicle. More particularly, the present disclosure is directed to a transfer case equipped with a two-speed range unit, a mode clutch assembly and a power-operated actuation mechanism for controlling coordinated actuation of the range unit and the mode clutch assembly.

### BACKGROUND

Due to the popularity of four-wheel drive vehicles, a number of power transfer systems are currently being used in vehicular drivetrain applications for selectively directing power (i.e., drive torque) from the powertrain to all four wheels of the vehicle. In many power transfer systems, a transfer case is incorporated into the drivetrain and is operable in a four-wheel drive mode for delivering drive torque from the powertrain to both the front and rear wheels. Many conventional transfer cases are equipped with a mode shift mechanism having a dog-type mode clutch that can be selectively actuated to shift between a two-wheel drive mode and a part-time four-wheel drive mode. In addition, many transfer cases also include a two-speed range shift mechanism having a dog-type range clutch which can be selectively actuated by the vehicle operator for shifting between four-wheel high-range and low-range drive modes.

It is also known to use adaptive power transfer systems for automatically biasing power between the front and rear wheels, without any input or action on the part of the vehicle operator, when traction is lost at either the front or rear wheels. Modernly, it is known to incorporate such a torque “on-demand” feature into a transfer case by replacing the mechanically-actuated mode clutch with a multi-plate clutch assembly and a power-operated clutch actuator that is interactively associated with an electronic control system. During normal road conditions, the clutch assembly is typically maintained in a released condition such that drive torque is only delivered to the rear wheels. However, when sensors detect a low traction condition, the control system actuates the clutch actuator for engaging the clutch assembly to deliver drive torque to the front wheels. Moreover, the amount of drive torque transferred through the clutch assembly to the non-slipping wheels can be varied as a function of specific vehicle dynamics, as detected by the sensors. Such on-demand clutch control systems can also be used in full-time transfer cases to adaptively bias the torque distribution ratio across an interaxle differential.

In some two-speed transfer cases, actuation of the range shift mechanism and the clutch assembly are independently controlled by separate power-operated actuators. For example, U.S. Pat. No. 5,407,024 discloses a two-speed range shift mechanism actuated by an electric motor and a clutch assembly actuated by an electromagnetic ball ramp unit. In an effort to reduce cost and complexity, some transfer cases are equipped with a single power-operated actuator that is operable to coordinate actuation of both the range shift mechanism and the clutch assembly. In particular, U.S. Pat. Nos. 5,363,938 and 5,655,986 each illustrate a transfer case equipped with a motor-driven cam having a pair of cam surfaces adapted to coordinate actuation of the range shift mechanism and the clutch assembly for establishing a plurality of distinct two-wheel and four-wheel drive modes. Examples of other transfer cases equipped with a single power-operated actuator for controlling coordinated engagement of the range shift mechanism and the mode clutch assembly are disclosed in U.S. Pat. Nos. 6,645,109; 6,783,475; 6,802,794; 6,905,436; 6,929,577 and 7,033,300.

While conventional transfer cases equipped with coordinated clutch actuation systems have been commercially successful, a need still exists to develop alternative clutch actuation systems which further reduce the cost and complexity of two-speed actively-controlled transfer cases.

### SUMMARY

A transfer case equipped with a two-speed range unit, a mode clutch assembly and a power-operated actuation mechanism for controlling coordinated actuation of the range unit and the mode clutch assembly is disclosed. In addition, the transfer case is interactively associated with a control system for controlling operation of the power-operated actuation mechanism to establish a plurality of distinct two-wheel and four-wheel drive modes.

### BRIEF DESCRIPTION OF THE DRAWINGS

Further objects, features and advantages of the present disclosure will become apparent from analysis of the following written specification including the appended claims, and the accompanying drawings in which:

FIG. 1 is a diagrammatical illustration of a four-wheel drive vehicle equipped with a transfer case and clutch control system according to the present disclosure;

FIGS. 2 and 3 are sectional views of a transfer case constructed according to the present disclosure to include a two-speed range unit, an on-demand mode clutch assembly and a power-operated actuation mechanism;

FIG. 4 is an enlarged partial view of FIG. 3 showing various components of the two-speed range unit and the mode clutch assembly;

FIG. 5 is an enlarged partial view of a complete power-operated actuation mechanism in greater detail;

FIG. 6 is a graph depicting a contour of a mode cam of the present disclosure;

FIG. 7 is a sectional side view of another transfer case;

FIGS. 8 through 13 are sectional views showing the mode cam rotated to various positions for establishing different drive modes;

FIG. 14 is a sectional side view of another transfer case; and

FIG. 15 is a plan view of an alternate actuation mechanism.

### DETAILED DESCRIPTION OF THE PREFERRED EMBODIMENTS

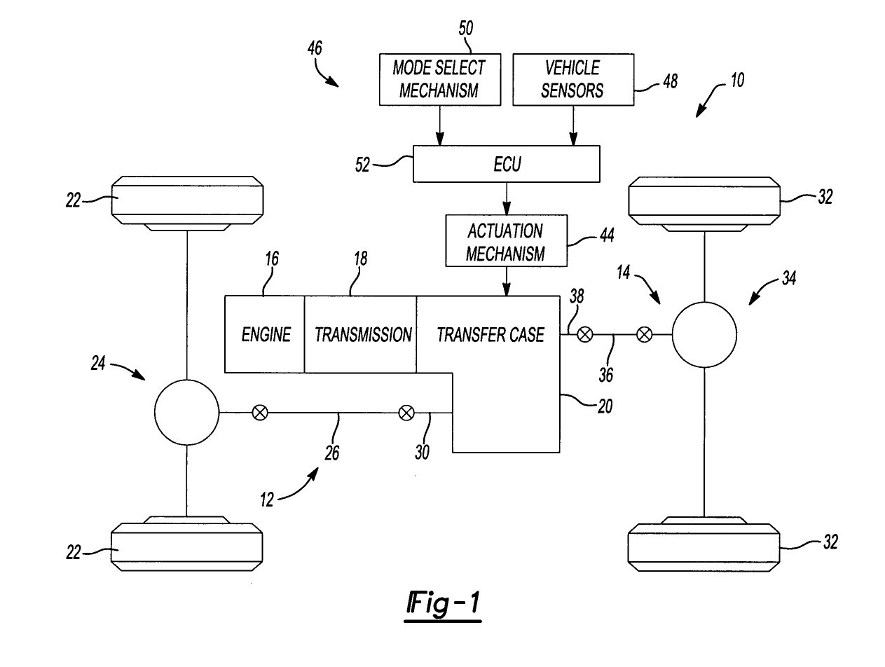

Referring now to FIG. 1 of the drawings, a four-wheel drive vehicle 10 is schematically shown to include a front driveline 12, a rear driveline 14 and a powertrain for generating and selectively delivering rotary tractive power (i.e., drive torque) to the drivelines. The powertrain is shown to include an engine 16 and a transmission 18 which may be of either the manual or automatic type. In the particular embodiment shown, vehicle 10 further includes a transfer case 20 for transmitting drive torque from the powertrain to front driveline 12 and rear driveline 14. Front driveline 12 includes a pair of front wheels 22 connected via a front axle assembly 24 and a front propshaft 26 to a front output shaft 30 of transfer case 20. Similarly, rear driveline 14 includes a pair of rear wheels 32 connected via a rear axle assembly 34 and a rear propshaft 36 to a rear output shaft 38 of transfer case 20.

As will be further detailed, transfer case 20 is equipped with a two-speed range unit 40, a mode clutch assembly 42 and a power-operated actuation mechanism 44 that is operable to control coordinated shifting of range unit 40 and adaptive engagement of mode clutch assembly 42. In addition, a control system 46 is provided for controlling actuation of actuation mechanism 44. Control system 46 includes vehicle sensors 48 for detecting real time operational characteristics of motor vehicle 10, a mode select mechanism 50 for permitting the vehicle operator to select one of the available drive modes and an electronic control unit (ECU) 52 that is operable to generate electric control signals in response to input signals from sensors 48 and mode signals from mode select mechanism 50.

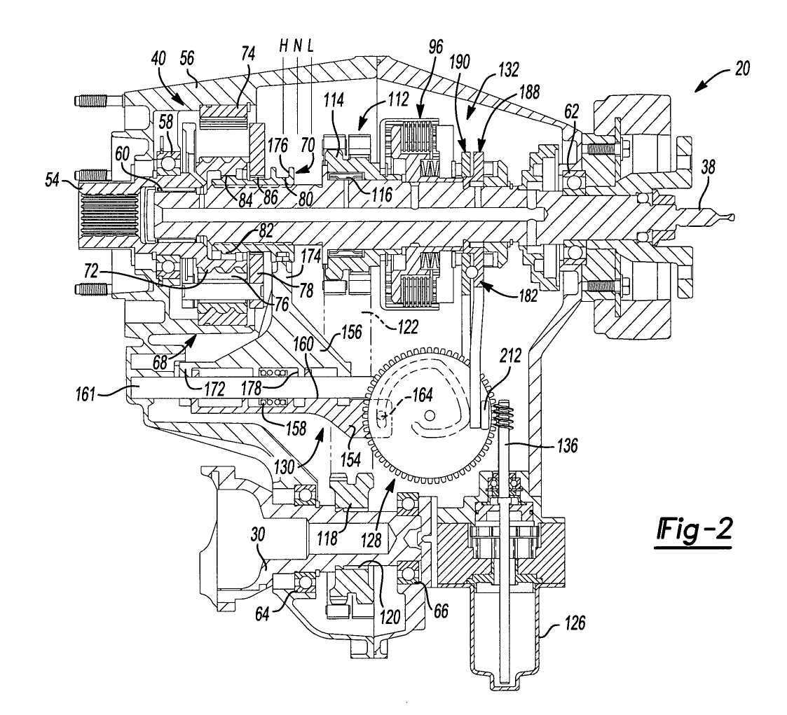

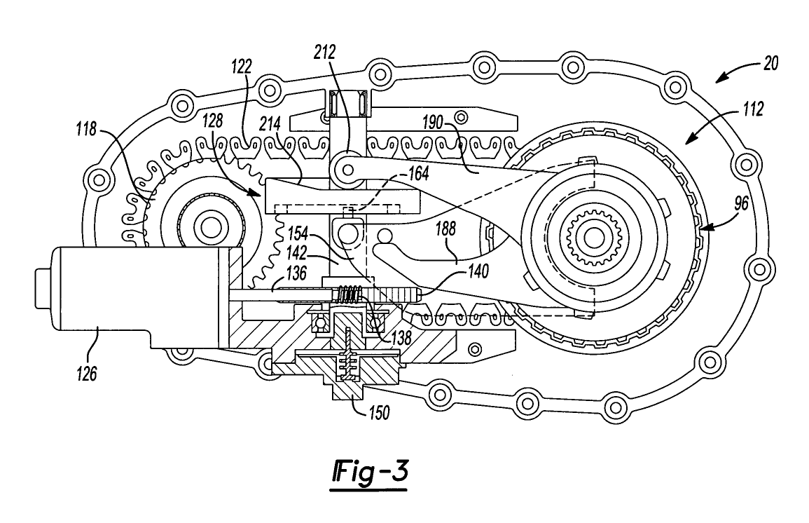

FIGS. 2-6 depict transfer case 20 including an input shaft 54 that is adapted for driven connection to the output shaft of transmission 18. Input shaft 54 is supported in a housing 56 by a bearing assembly 58 for rotation about a first rotary axis. Rear output shaft 38 is supported between input shaft 54 and housing 56 for rotation about the first rotary axis via a pair of laterally-spaced bearing assemblies 60 and 62. In addition, front output shaft 30 is supported in housing 56 for rotation about a second rotary axis via a pair of bearing assemblies 64 and 66.

Range unit 40 is shown to generally include a planetary gearset 68 and a dog clutch 70. Planetary gearset 68 has a sun gear 72 driven by input shaft 54, a ring gear 74 non-rotatably fixed to housing 56 and a plurality of planet gears 76 rotatably supported from a planet carrier 78. As seen, planet gears 76 are meshed with both sun gear 72 and ring gear 74. Planetary gearset 68 functions to drive planet carrier 78 at a reduced speed relative to input shaft 54. Dog clutch 70 includes a shift collar 80 coupled via a spline connection for rotation with and axial sliding movement on rear output shaft 38. Shift collar 80 has external clutch teeth 82 adapted to selectively engage either internal clutch teeth 84 formed on input shaft 54 or internal clutch teeth 86 formed on a carrier ring associated with planet carrier 78. Shift collar 80 is shown located in a high (H) range position such that its clutch teeth 82 are engaged with clutch teeth 84 on input shaft 54. As such, a direct speed ratio or “high-range” drive connection is established between input shaft 54 and rear output shaft 38. Shift collar 80 is axially moveable on rear output shaft 38 from its H range position through a central neutral (N) position into a low (L) range position. Location of shift collar 80 in its N position functions to disengage its clutch teeth 82 from both input shaft clutch teeth 84 and carrier clutch teeth 86, thereby uncoupling rear output shaft 38 from driven connection with input shaft 54. In contrast, movement of shift collar 80 into its L range position causes its clutch teeth 82 to engage clutch teeth 86 on planet carrier 78, thereby establishing a reduced speed ratio or “low-range” drive connection between input shaft 54 and rear output shaft 38.

It will be appreciated that planetary gearset 68 and non-synchronized dog clutch 70 function to provide transfer case 20 with a two-speed (i.e., high-range and low-range) feature. However, the non-synchronized range shift unit disclosed could be easily replaced with a synchronized range shift system to permit “on-the-move” range shifting between the high-range and low-range drive modes without the need to stop the motor vehicle. Furthermore, any two-speed reduction unit having a shift member axially moveable to establish first and second drive connections between input shaft 54 and rear output shaft 38 is considered to be within the scope of this invention.

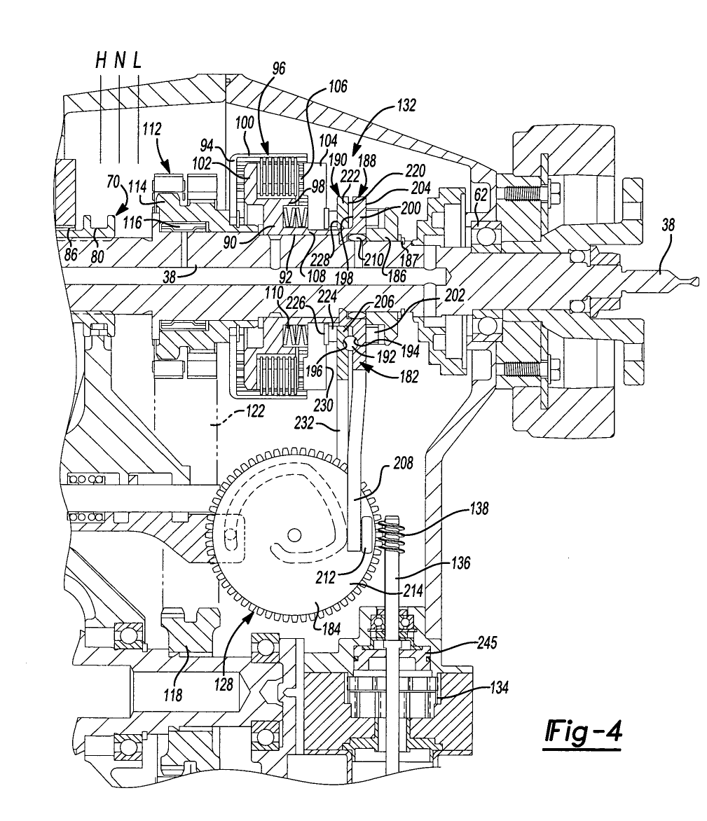

Referring primarily to FIG. 4, mode clutch assembly 42 is shown to include a clutch hub 90 fixed via a spline connection 92 for rotation with rear output shaft 38, a clutch drum 94 and a multi-plate clutch pack 96 operably disposed between hub 90 and drum 94. As seen, clutch pack 96 includes a set of inner clutch plates splined to a cylindrical rim segment 98 of clutch hub 90 and which are alternately interleaved with a set of outer clutch plates splined to a cylindrical rim segment 100 of drum 94. Clutch pack 96 is retained for limited sliding movement between a reaction plate segment 102 of clutch hub 90 and a pressure plate 104. Pressure plate 104 has a face surface 106 adapted to engage and apply a compressive clutch engagement force on clutch pack 96. Pressure plate 104 is splined to rim segment 98 for common rotation with clutch hub 90 and is further supported for sliding movement on a tubular sleeve segment 108 of clutch hub 90. A return spring 110 is provided between hub 90 and pressure plate 104 for normally biasing pressure plate 104 away from engagement with clutch pack 96.

Upon engagement of mode clutch assembly 42, drive torque is transmitted from rear output shaft 38 through clutch pack 96 and a transfer assembly 112 to front output shaft 30. Transfer assembly 112 includes a first sprocket 114 rotatably supported by bearing assemblies 116 on rear output shaft 38, a second sprocket 118 fixed via a spline connection 120 to front output shaft 30 and a power chain 122 encircling sprockets 114 and 118. Clutch drum 94 is fixed for rotation with first sprocket 114 such that drive torque transferred through clutch pack 96 is transmitted through transfer assembly 112 to front output shaft 30.

Pressure plate 104 is axially moveable relative to clutch pack 96 between a first or “released” position and a second or “locked” position. With pressure plate 104 in its released position, a minimum clutch engagement force is exerted on clutch pack 96 such that virtually no drive torque is transferred through mode clutch assembly 42 so as to establish a two-wheel drive mode. Return spring 110 is arranged to normally urge pressure plate 104 toward its released position. In contrast, location of pressure plate 104 in its locked position causes a maximum clutch engagement force to be applied to clutch pack 96 such that front output shaft 30 is, in effect, coupled for common rotation with rear output shaft 38 so as to establish a locked or “part-time” four-wheel drive mode. Therefore, accurate control of the position of pressure plate 104 between its released and locked positions permits adaptive regulation of the torque transfer between rear output shaft 38 and front output shaft 30, thereby permitting establishment of an adaptive or “on-demand” four-wheel drive mode.

Power-operated actuation mechanism 44 is operable to coordinate movement of shift collar 80 between its three distinct range positions with movement of pressure plate 104 between its released and locked positions. In its most basic form, actuation mechanism 44 includes an electric motor 126, a cam plate 128 driven by electric motor 126, a range actuator assembly 130 and a mode actuator assembly 132. A reduction geartrain 134 provides a drive connection between an output spindle of electric motor 126 and a driven shaft 136. Reduction geartrain 134 may include a planetary gearset positioned within a common housing of electric motor 126. A worm 138 is fixed to driven shaft 136 and positioned in driving engagement with a worm gear 140 fixed to a transfer shaft 142. Cam plate 128 is also fixes for rotation with transfer shaft 142. It should be appreciated that worm gear 140 may alternatively be formed on an outer diameter of cam plate 128. As such, the need for a separate worm gear 140 would be alleviated. Actuation of electric motor 126 causes worm 138 to rotate worm gear 140 and cam plate 128 about an axis extending perpendicular to an axis of rotation of rear output shaft 38. The cumulative reduction ratio provided by geartrain 134 and the worm gear set permits the use of a smaller, low power electric motor. An angular position sensor or encoder 150 is mounted to cam plate 128 for providing ECU 52 with an input signal indicative of the angular position of cam plate 128. Depending on the speed and torque requirements of actuation mechanism 44, reduction geartrain 134 may not be required. In this instance, only worm gear 140 and worm 138 provide torque multiplication from electric motor 126.

Range actuator assembly 130 is operable to convert bi-directional rotary motion of cam plate 128 into bi-directional translational movement of shift collar 80 between its three distinct range positions. Referring primarily to FIG. 2, range actuator assembly 130 is shown to generally include a range shuttle 154, a range fork 156 and a spring-biasing unit 158. Range shuttle 154 is a tubular member having an inner diameter surface 160 journalled for sliding movement on a range shaft 161. An elongated shift slot 162 is formed on one face of cam plate 128 and receives a follower pin 164 that is fixed to range shuttle 154. Shift slot 162 includes a high-range dwell segment 166, a neutral segment 167, a low-range dwell segment 168, a first shift segment 170 interconnecting high-range dwell segment 166 and neutral segment 167, and a second shift segment 169 interconnecting low-range dwell segment 168 and neutral segment 167. Range fork 156 includes a sleeve segment 172 supported for sliding movement on range shaft 161 and a fork segment 174 which extends from sleeve segment 172 into an annular groove 176 formed in shift collar 80. Sleeve segment 172 defines an interior chamber 178 within which spring-biasing unit 158 is located. Spring-biasing unit 158 is operably disposed between range shuttle 154 and sleeve segment 172 of range fork 156. Spring-biasing unit 158 functions to urge range fork 156 to move axially in response to axial movement of range shuttle 154 while its spring compliance accommodates tooth “block” conditions that can occur between shift collar clutch teeth 82 and input shaft clutch teeth 84 or carrier clutch teeth 86. As such, spring-biasing unit 158 assures that range fork 156 will complete axial movement of shift collar 80 into its H and L range positions upon elimination of any such tooth block condition.

Range actuator assembly 130 is arranged such that axial movement of range shuttle 154 results from movement of follower pin 164 within shift segment 170 of shift slot 162 in response to rotation of cam plate 128. As noted, such movement of range shuttle 154 causes range fork 156 to move shift collar 80 between its three distinct range positions H, N and L. Specifically, when it is desired to shift range unit 40 into its high-range drive mode, electric motor 126 rotates driven shaft 136 in a first direction which, in turn, causes concurrent rotation of cam plate 128 due to the worm 138 and worm gear 140 interface. Such rotation causes follower pin 164 to move within shift segment 170 of shift slot 162 for axially moving range shuttle 154 and range fork 156 until shift collar 80 is located in its H range position. With shift collar 80 in its H range position, the high-range drive connection is established between input shaft 54 and rear output shaft 38. Continued rotation of cam plate 128 in the first direction causes follower pin 164 to exit shift segment 170 of shift slot 162 and enter high-range dwell segment 166 for preventing further axial movement of range shuttle 154, thereby maintaining shift collar 80 in its H range position. The length of high-range dwell segment 166 of shift slot 162 is selected to permit sufficient additional rotation of cam plate 128 in the first rotary direction to accommodate actuation of mode clutch assembly 42 by mode actuator assembly 132.

With shift collar 80 in its H range position, subsequent rotation of cam plate 128 in the opposite or second direction causes follower pin 164 to exit high-range dwell segment 166 and re-enter shift segment 170 of shift slot 162 for causing range shuttle 154 to begin moving shift collar 80 from its H range position toward its N range position. Upon continued rotation of cam plate 128 in the second direction, follower pin 164 exits shift segment 170 of shift slot 162 and enters neutral segment 167. Follower pin 164 subsequently enters second shift segment 169 to locate shift collar 80 in its L range position, whereby the low-range drive connection between planet carrier 78 and rear output shaft 38 is established. Continued cam plate 128 rotation causes follower pin 164 to enter low-range dwell segment 168 to maintain shift collar 80 in the L range position. The length of low-range dwell segment 168 of shift slot 162 is selected to permit additional rotation of cam plate 128 in the second rotary direction to accommodate actuation of mode clutch assembly 42.

Mode actuator assembly 132 is operable to convert bi-directional rotary motion of cam plate 128 into bi-directional translational movement of pressure plate 104 between its released and locked positions so as to permit adaptive regulation of the drive torque transferred through mode clutch assembly 42 to front output shaft 30. In general, mode actuator assembly 132 includes a ballramp unit 182 acting in cooperation with a mode cam portion 184 of cam plate 128. Mode cam portion 184 is formed on the opposite of cam plate 128 as shift slot 162. Ballramp unit 182 is supported on rear output shaft 38 between a collar 186 and pressure plate 104. A lock ring 187 axially locates collar 186 in rear output shaft 38. Ballramp unit 182 includes a first cam member 188, a second cam member 190 and balls 192 disposed in aligned sets of tapered grooves 194 and 196 formed in corresponding face surfaces of cam members 188 and 190. In particular, grooves 194 are formed in a first face surface 198 on a cam ring segment 200 of first cam member 188. As seen, a thrust bearing assembly 202 is disposed between collar 186 and a second face surface 204 of cam ring segment 200. First cam member 188 further includes a tubular sleeve segment 206 and an elongated lever segment 208. Sleeve segment 206 is supported on rear output shaft 38 via a bearing assembly 210. Lever segment 208 has a roller 212 mounted at its terminal end. Roller 212 engages mode cam portion 184 along a contoured cam surface 214 of cam plate 128 and is able to rotate relative to lever segment 208 and mode cam portion 184.

Second cam member 190 of ballramp unit 182 has its grooves 196 formed in a first face surface 220 of a cam ring segment 222 that is shown to generally surround portions of sleeve segment 206 of first cam member 188. A thrust bearing assembly 224 and thrust ring 226 are disposed between a second face surface 228 of cam ring segment 222 and a face surface 230 of pressure plate 104. Second cam member 190 further includes an elongated lever segment 232 having its terminal end restricted from rotation.

As will be detailed, the contour of cam surface 214 on mode cam portion 184 functions to control angular movement of first cam member 188 relative to second cam member 190 in response to rotation of cam plate 128. Such relative angular movement between cam members 188 and 190 causes balls 192 to travel along grooves 194 and 196 which, in turn, causes axial movement of second cam member 190. Such axial movement of second cam member 190 functions to cause corresponding axial movement of pressure plate 104 between its released and locked positions, thereby controlling the magnitude of the clutch engagement force applied to clutch pack 96.

Due to engagement of roller 212 with cam surface 214 on mode cam portion 184, first cam member 188 is angularly moveable relative to second cam member 190 between a first or “retracted” position and a second or “extended” position in response to rotation of cam plate 128. With first cam member 188 in its retracted position, return spring 110 biases pressure plate 104 to its released position which, in turn, urges balls 192 to be located in deep end portions of aligned grooves 194 and 196. Such movement of first cam member 188 to its angularly retracted position relative to second cam member 190 also functions to locate second cam member 190 in an axially retracted position relative to clutch pack 96. While not shown, a biasing unit can be provided between lever segments 208 and 232 to assist return spring 110 in normally urging first cam member 188 toward its retracted position. In contrast, angular movement of first cam member 188 to its extended position causes balls 192 to be located in shallow end portions of aligned grooves 194 and 196 which causes movement of second cam member 190 to an axially extended position relative to clutch pack 96. Such axial movement of second cam member 190 causes pressure plate 104 to be moved to its locked position in opposition to the biasing exerted thereon by return spring 110. Accordingly, control of angular movement of first cam member 188 between its retracted and extended positions functions to cause concurrent movement of pressure plate 104 between its released and locked positions.

As previously noted, cam plate 128 includes cam surface 214 on one side and shift slot 162 on the opposite side. Cam plate 128 is configured to coordinate movement of shift collar 80 and pressure plate 104 in response to energization of electric motor 126 and resultant rotation of cam plate 128 for establishing a plurality of different drive modes. According to one possible control arrangement, mode selector 50 could permit the vehicle operator to select from a number of different two-wheel and four-wheel drive modes including, for example, a two-wheel high-range drive mode, an on-demand four-wheel high-range drive mode, a part-time four-wheel high-range drive mode, a neutral mode and a part-time four-wheel low-range drive mode. Specifically, control system 46 functions to control the rotated position of cam plate 128 in response to the mode signal delivered to ECU 52 by mode selector 50 and the sensor input signals sent by sensors 48 to ECU 52.

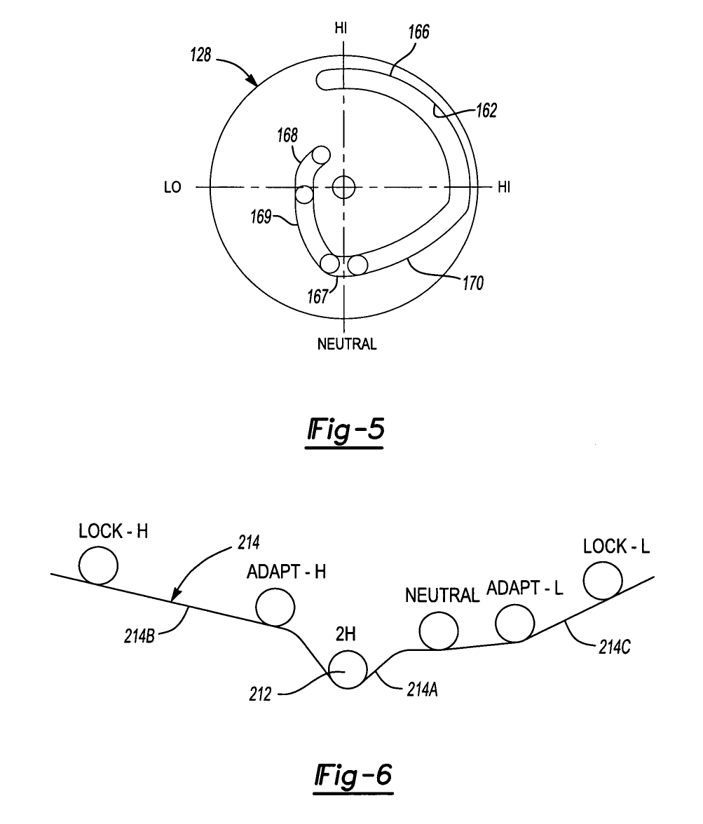

FIG. 6 illustrates the contour of cam surface 214 as a line graph. The cam surface includes various sectors corresponding to LOCK-H, ADAPT-H, 2H, NEUTRAL, ADAPT-L AND LOCK-L positions. Cam plate 128 may be rotated to any number of these positions including the “2H” position required to establish the two-wheel high-range drive mode. As understood, the two-wheel high-range drive mode is established when shift collar 80 is located in its H range position and pressure plate 104 is located in its released position relative to clutch pack 96. As such, input shaft 54 drives rear output shaft 38 at a direct speed ratio while mode clutch assembly 42 is released such that all drive torque is delivered to rear driveline 14. Roller 212 is shown engaging a detent portion of a first cam segment 214A of cam surface 214 on mode cam portion 184 which functions to locate second cam member 190 in its retracted position when cam plate 128 is in the 2H position.

If the on-demand four-wheel high-range drive mode is thereafter selected, electric motor 126 is energized to initially rotate cam plate 128 in a first direction from its 2H position to the “ADAPT-H” position. In this rotated position of cam plate 128, follower pin 164 is located within high-range dwell segment 166 of shift slot 162 in cam plate 128 such that shift collar 80 is maintained in its H range position for maintaining the direct drive connection between input shaft 54 and rear output shaft 38. However, such rotation of cam plate 128 to its ADAPT-H position causes concurrent rotation of mode cam portion 184 to the position shown which, in turn, causes roller 212 to engage a first portion of a second cam segment 214B of mode cam surface 214. Such movement of roller 212 from first cam segment 214A to second cam segment 214B causes first cam member 188 to move angularly relative to second cam member 190 and move second cam member 190 from its retracted position to an intermediate or “ready” position. With second cam member 190 rotated to its ready position, ballramp unit 182 causes pressure plate 104 to move axially from its released position into an “adapt” position that is operable to apply a predetermined “preload” clutch engagement force on clutch pack 96. The adapt position of pressure plate 104 provides a low level of torque transfer across mode clutch assembly 42 required to take-up clearances in clutch pack 96 in preparation for adaptive control. Thereafter, ECU 52 determines when and how much drive torque needs to be transmitted across mode clutch assembly 42 to limit driveline slip and improve traction based on the current tractive conditions and operating characteristics detected by sensors 48. As an alternative, the adapt position for pressure plate 104 can be selected to partially engage mode clutch assembly 42 for establishing a desired front/rear torque distribution ratio (i.e., 10/90, 25/75, 40/60, etc.) between front output shaft 30 and rear output shaft 38.

The limits of adaptive control in the on-demand four-wheel high-range drive mode are established by controlling bi-directional rotation of cam plate 128 between its ADAPT-H and its “LOCK-H” position shown in FIG. 6. With cam plate 128 in its LOCK-H position, second segment 214B of mode cam surface 214 causes second cam member 190 to move to its extended position, thereby causing pressure plate 104 to move to its locked position for fully engaging mode clutch assembly 42. This range of angular travel of cam plate 306 causes follower pin 164 to travel within high-range dwell segment 166 of shift slot 162 so as to maintain shift collar 80 in its H range position. However, such rotation of cam plate 128 results in roller 212 riding along second segment 214B of cam surface 214 which, in turn, controls movement of second cam member 190 between its ready position and its extended position. Bi-directional rotation of cam plate 128 within this range of travel is controlled by ECU 52 actuating electric motor 126 based on a pre-selected torque control strategy. As will be understood, any control strategy known in the art for adaptively controlling torque transfer across mode clutch assembly 42 can be utilized with the present invention.

If the vehicle operator selects the part-time four-wheel high-range drive mode, electric motor 126 is energized to rotate cam plate 128 in the first direction to its LOCK-H position. As such, shift collar 80 is maintained in its H range position and mode cam portion 184 causes second cam member 190 to move to its extended position which, in turn, moves pressure plate 104 to its locked position for fully engaging mode clutch assembly 42. To limit the on-time service requirements of electric motor 126, a power-off brake 245 associated with electric motor 126 can be engaged to brake rotation of the motor output so as to prevent back-driving of cam plate 128 for holding pressure plate 104 in its locked position. In this manner, electric motor 126 can be shut-off after the part-time four-wheel high-range drive mode has been established.

If the Neutral mode is selected, electric motor 126 is energized to rotate cam plate 128 in a second direction to the neutral position. Such rotation of cam plate 128 causes follower pin 164 to exit high-range dwell segment 166 and ride within shift segment 170 of shift slot 162 until shift collar 80 is located in its N position. Concurrently, rotation of mode cam portion 184 causes roller 212 to engage a portion of first segment 214A of cam surface 214 that is configured to move second cam member 190 to a position displaced from its retracted position. Such movement of second cam member 190 results in limited axial movement of pressure plate 104 from its released position toward clutch pack 96. Preferably, such movement of pressure plate 104 does not result in any drive torque being transferred through mode clutch assembly 42 to front driveline 12. Continued rotation of cam plate 128 in the second direction occurs when the part-time four-wheel low-range drive mode is selected. At an intermediate “ADAPT-L” position of cam plate 128, follower pin 164 enters low-range dwell segment 168 of shift slot 162 for locating shift collar 80 in its L range position. Mode cam portion 184 has likewise been rotated for locating roller 212 at the interface between first segment 214A of cam surface 214 and a third segment 214C thereof. The contour of third segment 214C is configured such that first cam member 188 is rotated to move second cam member 190 to its ready position. As previously noted, movement of second cam member 190 to its ready position causes pressure plate 104 to move axially to its adapt position. However, selection of the part-time four-wheel low-range drive mode causes continued rotation of cam plate 128 to its LOCK-L position. Low-range dwell segment 168 in shift slot 162 maintains shift collar 80 in its L range position while third segment 214C of mode cam surface 214 causes roller 212 to move second cam member 190 to its extended position, thereby moving pressure plate 104 to its locked position for fully engaging mode clutch assembly 42. Again, power-off brake 245 can be actuated to maintain cam plate 128 in its LOCK-L position.

Based on the preferred arrangement disclosed for actuation mechanism 44, cam plate 128 is rotatable through a first range of angular travel to accommodate range shifting of shift collar 80 as well as second and third ranges of angular travel to accommodate engagement of mode clutch assembly 42. In particular, the first range of angular travel for cam plate 128 is established between its ADAPT-H and ADAPT-L positions. The second range of travel for cam plate 128 is defined between its ADAPT-H and LOCK-H positions to permit adaptive control of mode clutch assembly 42 with shift collar 80 in the H range position. Likewise, the third range of cam plate travel is defined between its ADAPT-L and LOCK-L positions to permit actuation of mode clutch assembly 42 while shift collar 80 is in its L range position.

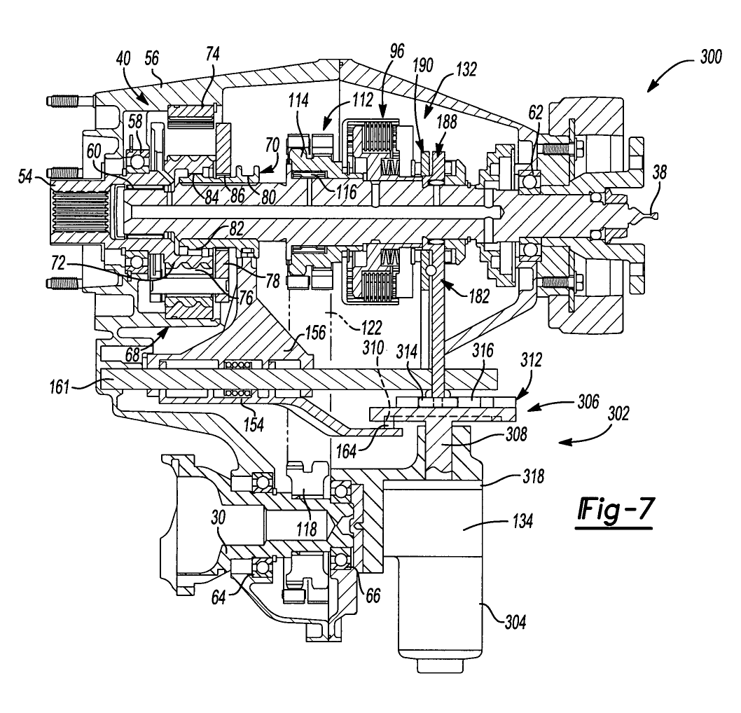

FIG. 7 illustrates another transfer case 300 equipped with a two-speed range unit, a mode clutch assembly and power-operated actuation mechanism operable to control coordinated shifting of the range unit and adaptive engagement of the mode clutch assembly. Transfer case 300 is substantially similar to transfer case 20 except that a different power-operated actuation mechanism 302 is implemented. Accordingly, like elements will retain their previously introduced reference numerals. Power-operated actuation mechanism 302 includes an electric motor 304, a cam plate 306 rotatably driven by electric motor 304, range actuator assembly 130 and mode actuator assembly 132. An output spindle of electric motor 304 is drivingly coupled to reduction geartrain 134. The output of geartrain 134 drives a shaft 308. Driven shaft 308 is affixed to cam plate 306 such that cam plate 306 rotates about the same axis of rotation as driven shaft 308. An elongated shift slot 310 is formed on one face of cam plate 306 and receives follower pin 164 that is fixed to range shuttle 154. Shift slot 162 is shaped as previously described in reference to transfer case 20. However, it should be appreciated that within transfer case 300, follower pin 164 extends along an axis substantially parallel to the axis about which motor 304 rotates while follower pin 164 of transfer case 20 extends along an axis perpendicular to the rotation of motor 304.

Actuation mechanism 302 is also operable to control mode actuator assembly 132. A mode cam 312 is coupled to or integrally formed with cam plate 306. A mode follower 314 is rotatably fixed to the terminal end of first cam member 188. Mode follower 314 rollingly engages a cam surface 316 formed on an outer peripheral edge of mode cam 312. As will be detailed, the contour of cam surface 316 on mode cam 312 functions to control angular movement of first cam member 188 relative to second cam member 190 in response to rotation of cam plate 306.

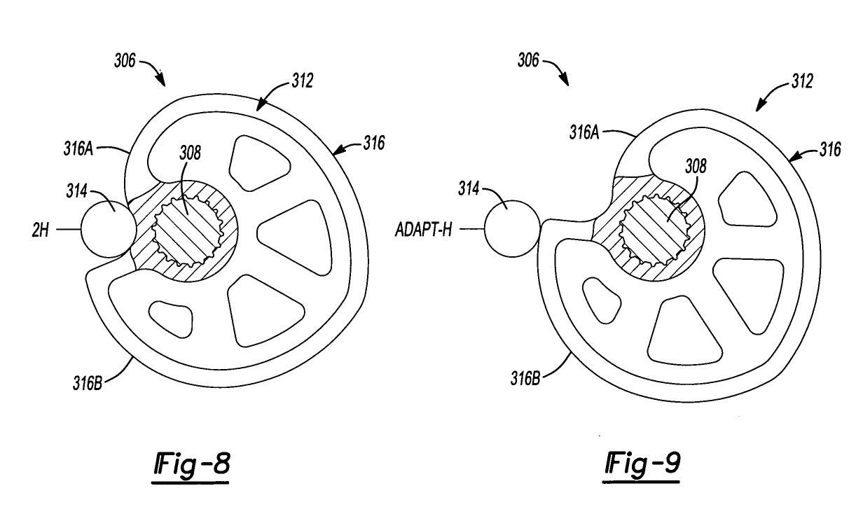

FIG. 8 illustrates cam plate 306 rotated to a “2H” position required to establish the two-wheel high-range drive mode. As understood, the two-wheel high-range drive mode is established when shift collar 80 is located in its H range position and pressure plate 104 is located in its released position relative to clutch pack 96. As such, input shaft 54 drives rear output shaft 38 at a direct speed ratio while mode clutch assembly 42 is released such that all drive torque is delivered to rear driveline 14. Mode follower 314 is shown engaging a detent portion of a first cam segment 316A of cam surface 316 on mode cam 312 which functions to locate second cam member 190 in its retracted position.

If the on-demand four-wheel high-range drive mode is thereafter selected, electric motor 304 is energized to initially rotate cam plate 306 in a first direction from its 2H position to the “ADAPT-H” position shown in FIG. 9. In this rotated position of cam plate 306, follower pin 164 is located within high-range dwell segment 166 of shift slot 162 in cam plate 306 such that shift collar 80 is maintained in its H range position for maintaining the direct drive connection between input shaft 54 and rear output shaft 38. However, such rotation of cam plate 306 to its ADAPT-H position causes concurrent rotation of mode cam 312 to the position shown which, in turn, causes mode follower 314 to engage a first end portion of a second cam segment 316B of mode cam surface 316. Such movement of mode follower 314 from first cam segment 316A to second cam segment 316B causes first cam member 188 to move angularly relative to second cam member 190 and move second cam member 190 from its retracted position to an intermediate or “ready” position. With second cam member 190 rotated to its ready position, ballramp unit 182 causes pressure plate 104 to move axially from its released position into an “adapt” position that is operable to apply a predetermined “preload” clutch engagement force on clutch pack 96. The adapt position of pressure plate 104 provides a low level of torque transfer across mode clutch assembly 42 required to take-up clearances in clutch pack 96 in preparation for adaptive control. Thereafter, ECU 52 determines when and how much drive torque needs to be transmitted across mode clutch assembly 42 to limit driveline slip and improve traction based on the current tractive conditions and operating characteristics detected by sensors 48. As an alternative, the adapt position for pressure plate 104 can be selected to partially engage mode clutch assembly 42 for establishing a desired front/rear torque distribution ratio (i.e., 10/90, 25/75, 40/60, etc.) between front output shaft 30 and rear output shaft 38.

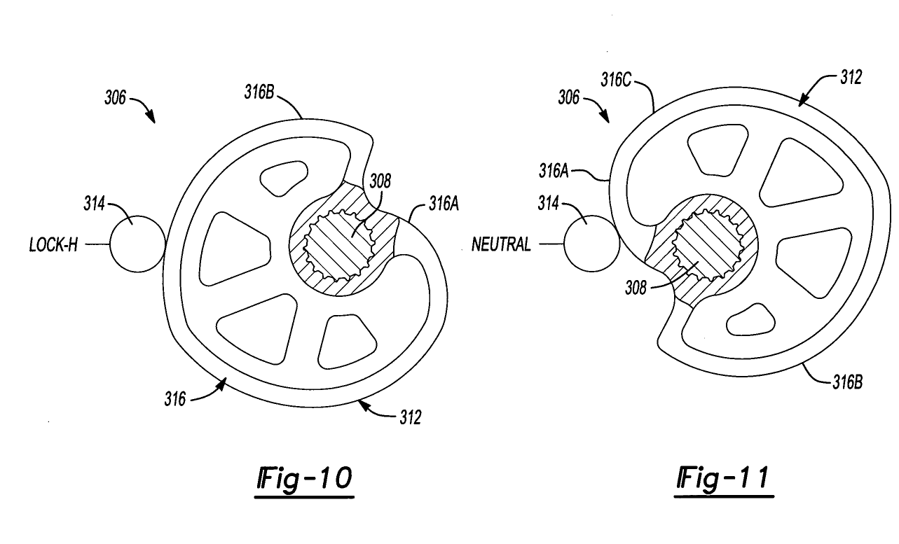

The limits of adaptive control in the on-demand four-wheel high-range drive mode are established by controlling bi-directional rotation of cam plate 306 between its ADAPT-H position of FIG. 9 and its “LOCK-H” position shown in FIG. 10. With cam plate 306 in its LOCK-H position, second segment 316B of mode cam surface 316 causes second cam member 190 to move to its extended position, thereby causing pressure plate 104 to move to its locked position for fully engaging mode clutch assembly 42. This range of angular travel of cam plate 306 causes follower pin 164 to travel within high-range dwell segment 166 of shift slot 162 so as to maintain shift collar 80 in its H range position. However, such rotation of cam plate 306 results in mode follower 314 riding along second segment 316B of cam surface 316 which, in turn, controls movement of second cam member 190 between its ready position and its extended position. Bi-directional rotation of cam plate 306 within this range of travel is controlled by ECU 52 actuating electric motor 304 based on a pre-selected torque control strategy. As will be understood, any control strategy known in the art for adaptively controlling torque transfer across mode clutch assembly 42 can be utilized with the present invention.

If the vehicle operator selects the part-time four-wheel high-range drive mode, electric motor 304 is energized to rotate cam plate 306 in the first direction to its LOCK-H position shown in FIG. 10. As such, shift collar 80 is maintained in its H range position and mode cam 312 causes second cam member 190 to move to its extended position which, in turn, moves pressure plate 104 to its locked position for fully engaging mode clutch assembly 42. To limit the on-time service requirements of electric motor 304, a power-off brake 318 associated with electric motor 304 can be engaged to brake rotation of the motor output so as to prevent back-driving of cam plate 306 for holding pressure plate 104 in its locked position. In this manner, electric motor 304 can be shut-off after the part-time four-wheel high-range drive mode has been established.

If the Neutral mode is selected, electric motor 304 is energized to rotate cam plate 306 in a second direction to the Neutral position shown in FIG. 11. Such rotation of cam plate 306 causes follower pin 164 to exit high-range dwell segment 166 and ride within shift segment 170 of shift slot 162 until shift collar 80 is located in its N position. Concurrently, rotation of mode cam 312 causes mode follower 314 to engage a portion of first segment 316A of cam surface 316 that is configured to move second cam member 190 to a position displaced from its retracted position. Such movement of second cam member 190 results in limited axial movement of pressure plate 104 from its released position toward clutch pack 96. Preferably, such movement of pressure plate 104 does not result in any drive torque being transferred through mode clutch assembly 42 to front driveline 12.

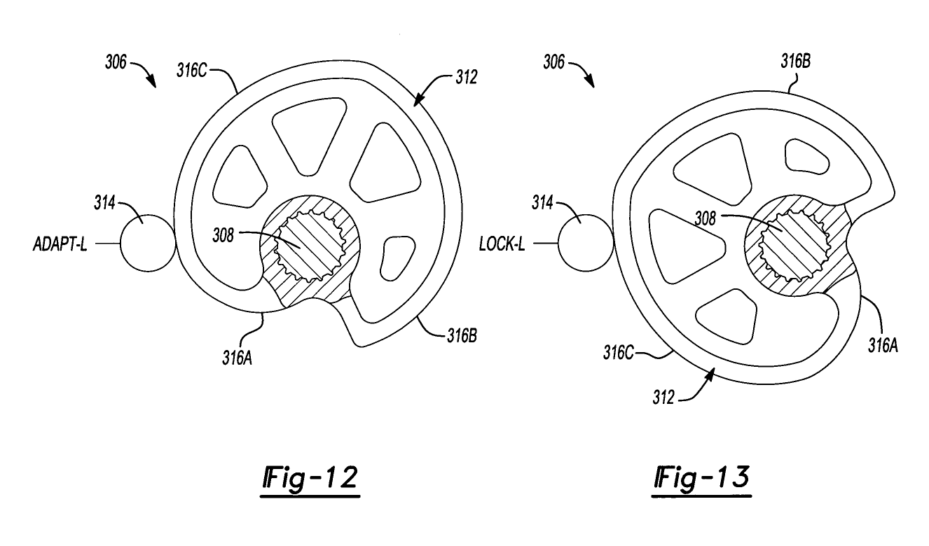

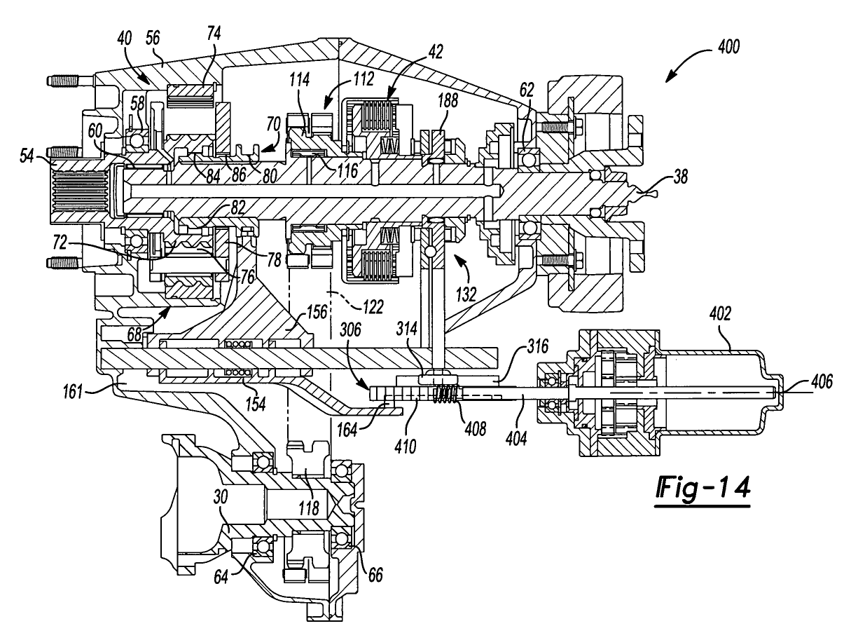

FIGS. 12 and 13 illustrate continued rotation of cam plate in the second direction which occurs when the part-time four-wheel low-range drive mode is selected. In particular, FIG. 12 shows an intermediate “ADAPT-L” position of cam plate 306 whereat follower pin 164 enters low-range dwell segment 168 of shift slot 162 for locating shift collar 80 in its L range position. Mode cam 312 has likewise been rotated for locating mode follower 314 at the interface between first segment 316A of cam surface 316 and a third segment 316C thereof. The contour of third segment 316C is configured such that first cam member 188 is rotated to move second cam member 190 to its ready position. As previously noted, movement of second cam member 190 to its ready position causes pressure plate 104 to move axially to its adapt position. However, selection of the part-time four-wheel low-range drive mode causes continued rotation of cam plate 306 to its LOCK-L position shown in FIG. 13. Low-range dwell segment 168 in shift slot 162 maintains shift collar 80 in its L range position while third segment 316C of mode cam surface 316 causes mode follower 314 to move second cam member 190 to its extended position, thereby moving pressure plate 104 to its locked position for fully engaging mode clutch assembly 42. Again, power-off brake 318 can be actuated to maintain cam plate 306 in its LOCK-L position.

Based on the preferred arrangement disclosed for actuation mechanism 302, cam plate 306 is rotatable through a first range of angular travel to accommodate range shifting of shift collar 80 as well as second and third ranges of angular travel to accommodate engagement of mode clutch assembly 42. In particular, the first range of angular travel for cam plate 306 is established between its ADAPT-H and ADAPT-L positions. The second range of travel for cam plate 306 is defined between its ADAPT-H and LOCK-H positions to permit adaptive control of mode clutch assembly 42 with shift collar 80 in the H range position. Likewise, the third range of cam plate travel is defined between its ADAPT-L and LOCK-L positions to permit actuation of mode clutch assembly 42 while shift collar 80 is in its L range position.

FIG. 14 depicts another transfer case 400. Transfer case 400 is substantially similar to transfer case 300. Accordingly, like elements will retain their previously introduced reference numerals. Transfer case 400 includes an electric motor 402 having a driven shaft 404 rotatable about an axis 406. Axis 406 extends substantially parallel to and offset from an axis of rotation of rear output shaft 38. Cam plate 306 continues to be rotatable about an axis extending substantially perpendicular to the axis about which rear output shaft 38 rotates as previously described. A worm 408 is fixed to driven shaft 404. Worm 408 is in meshed driving engagement with a worm gear 410 formed on an outer peripheral surface of cam plate 306. Accordingly, energization of electric motor 402 causes driven shaft 404 to rotate in one of two directions. Worm 408 rotates in the same direction as driven shaft 404 to cause cam plate 306 to rotate in response to worm gear 410 being driven by worm 408. As previously described, follower 164 is axially translatable in response to rotation of cam plate 306. Additionally, mode follower 314 follows the contour of cam surface 316 thereby selectively actuating mode clutch assembly 42 as previously described. The arrangement of electric motor 402, driven shaft 404 and cam plate 306 allows a designer to best utilize the space available for the transfer case by positioning electric motor 402 near rear output shaft 38 at a more aft location, if desired.

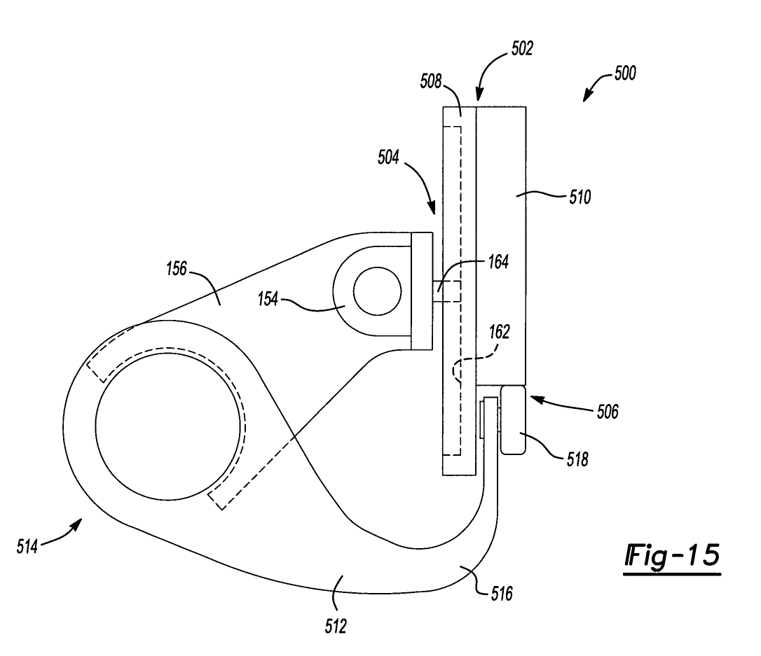

FIG. 15 depicts a portion of an alternate power-operated actuation mechanism 500. Actuation mechanism 500 is substantially similar to actuation mechanism 302. Accordingly, like elements will retain their previously introduced reference numerals. Actuation mechanism 500 includes a cam plate 502 driven by an electric motor (not shown), a range actuator assembly 504 and a mode actuator assembly 506. Rotation of cam plate 502 causes follower pin 164 to translate within shift slot 162. Range shuttle 154 is fixed to follower pin 164 to cause range fork 156 to translate as previously described.

A range cam portion 508 of cam plate 502 includes shift slot 162 and has an outer diameter larger than a mode cam 510 portion of cam plate 502. To achieve a compact overall size of actuation mechanism 500, a cam member 512 of a mode actuator 514 includes a curved portion 516 to reach around range cam portion 508. A roller 518 is rotatably coupled to a distal end of cam member 512. Roller 518 is in driven engagement with mode cam 510. The relatively compact package is formed through the use of the curved arm of cam member 512.

It should be appreciated that the various drive elements including worm gear drives, planetary gearsets, face cams, edge cams, and ball ramp actuators may be combined with one another to define a transfer case contemplated by the inventor but not particularly described in detail or shown in any one of the particular Figures.

Furthermore, the foregoing discussion discloses and describes merely exemplary embodiments of the present disclosure. One skilled in the art will readily recognize from such discussion, and from the accompanying drawings and claims, that various changes, modifications and variations may be made therein without departing from the spirit and scope of the disclosure as defined in the following claims.

What is claimed is:

1. A transfer case comprising:
an input shaft;
first and second output shafts;
a range unit driven at a reduced speed relative to said input shaft;
a range clutch operable in a first range position to establish a drive connection between said input shaft and said first output shaft and further operable in a second range position to establish a drive connection between said range unit and said first output shaft;
a mode clutch operable in a first mode position to disengage said second output shaft from driven engagement with said first output shaft and further operable in a second mode position to establish a drive connection between said first output shaft and said second output shaft;
a cam plate having a shift slot and a contoured cam surface;
an electric motor rotating said cam plate;
a range actuator including a member moveable along an axis being driven by said shift slot for moving said range clutch between its first and second range positions;
a mode actuator including a cam follower being driven by said cam surface in a direction substantially perpendicular to said axis for moving said mode clutch between its first and second mode positions; and
a control system for actuating said motor to control the magnitude and direction of rotation of said cam plate so as to coordinate movement of said range clutch and said mode clutch.

2. The transfer case of claim 1 wherein said cam plate is rotatable through three distinct ranges of travel.

3. The transfer case of claim 2 wherein rotation of said cam plate through a first range of travel causes said range actuator to move said range clutch between its first and second range positions while said mode actuator maintains said mode clutch in its first mode position, and wherein rotation of said cam plate through a second range of travel causes said range actuator to maintain said range clutch in its first range position while said mode actuator moves said mode clutch between its first and second mode positions.

4. The transfer case of claim 3 wherein rotation of said cam plate through a third range of travel causes said range actuator to maintain said range clutch in its second range position while said mode actuator moves said mode clutch between its first and second mode positions.

5. The transfer case of claim 1 wherein said cam plate includes a first portion having said shift slot within which said member is positioned, said shift slot being configured to convert rotary movement of said cam plate to axial movement of a shift fork coupled to said range clutch.

6. The transfer case of claim 5 wherein said range actuator includes a range shuttle fixed to said member and a biasing mechanism interconnecting said shift fork and said range shuttle for moving said range clutch between its first and second range positions.

7. The transfer case of claim 5 wherein said cam plate includes a second portion with said cam surface upon which said cam follower of said mode actuator is positioned, said mode actuator including a ballramp unit having first and second cam members being rotatable and axially moveable relative to one another and rollers disposed in cam grooves formed between said first and second cam members, wherein said mode clutch is moveable between its first and second mode positions in response to movement of one of said first and second cam members between a retracted position and an extended position, and wherein said cam surface is configured to cause movement of one of said first and second cam members between its retracted and extended position in response to rotation of said cam plate.

8. The transfer case of claim 7 wherein said cam surface is formed on a first face of said cam plate and said shift slot is formed on a second face opposite said first face.

9. The transfer case of claim 8 wherein said cam plate rotates about an axis extending perpendicular to an axis of rotation of said first and second output shafts.

10. The transfer case of claim 9 wherein said electric motor has an output spindle rotating along an axis coincident with said axis of cam plate rotation.

11. The transfer case of claim 9 wherein said electric motor has an output spindle rotating along an axis perpendicular to said axis of cam plate rotation.

12. The transfer case of claim 7 wherein said cam surface is formed on an outer peripheral edge of said cam plate.

13. The transfer case of claim 7 wherein said ball ramp unit and said follower are positioned on one side of said cam plate.

14. The transfer case of claim 13 wherein one of said first and second cam members includes a curved arm portion to reach around said first portion of said cam plate.

15. The transfer case of claim 1 further including a worm gear drive interconnecting said electric motor and said cam plate.

16. A transfer case comprising:
an input shaft;
first and second output shafts;
a range unit driven at a reduced speed relative to said input shaft;
a range clutch operable in a first range position to establish a drive connection between said input shaft and said first output shaft and further operable in a second range position to establish a drive connection between said range unit and said first output shaft;
a mode clutch operable in a first mode position to disengage said second output shaft from driven engagement with said first output shaft and further operable in a second mode position to establish a drive connection between said first output shaft and said second output shaft;
a range actuator for moving said range clutch between its first and second range positions;
a mode actuator for moving said mode clutch between its first and second mode positions;
a cam plate having a shift slot and a cam surface, said shift slot driving an axially moveable member of said range actuator, said cam surface driving a cam follower of said mode actuator, wherein rotation of said cam plate provides coordinated control of said range clutch and said mode clutch; and
an electric motor rotating said cam plate.

17. The transfer case of claim 16 further including a control system for actuating said motor to control the magnitude and direction of rotation of said cam plate so as to coordinate movement of said range clutch and said mode clutch.

18. The transfer case of claim 17 wherein said mode actuator includes a ballramp unit having first and second cam members being rotatable and axially moveable relative to one another and rollers disposed in cam grooves formed between said first and second cam members, wherein said mode clutch is moveable between its first and second mode positions in response to movement of one of said first and second cam members between a retracted position and an extended position, and wherein said cam surface is configured to cause movement of one of said first and second cam members between its retracted and extended position in response to rotation of said cam plate.

19. The transfer case of claim 18 wherein said cam surface is formed on a first face of said cam plate and said shift slot is formed on a second face opposite said first face.

20. The transfer case of claim 19 wherein said cam plate rotates about an axis extending perpendicular to axes of rotation of said first and second output shafts.

21. The transfer case of claim 20 wherein said electric motor has an output spindle rotating along an axis coincident with said axis of cam plate rotation.

22. The transfer case of claim 18 further including a gearset interconnecting said electric motor and said cam plate, wherein a worm gear is formed on a portion of said cam plate.
